(19) United States
(12) Patent Application Publication
(10) Pub. No.: US 2014/0074816 A1
(43) Pub. Date: Mar. 13, 2014

(54) METHOD AND APPARATUS FOR GENERATING A QUERY CANDIDATE SET

(71) Applicant: REDIFF.COM INDIA LIMITED, Mumbai (IN)

(72) Inventors: KALPANA BANERJEE, Chennai (IN); Surabhi Khandavalli, Navi Mumbai (IN); Vishal Shah, Mumbai (IN); Gaurav Ruhela, New Delhi (IN)

(21) Appl. No.: 13/927,004

(22) Filed: Jun. 25, 2013

(30) Foreign Application Priority Data
Jun. 25, 2012 (IN) 1820/MUM/2012

(51) Int. Cl. G06F 17/30

(52) U.S. Cl. CPC G06F 17/30867; G06F 17/30038
USPC 707/710; 707/750

(57) ABSTRACT

The present invention provides a method and apparatus for generating a query candidate set. The method comprises automatically tagging a sequence of words in a digital document to obtain a sequence of tags, comparing the sequence of tags with one or more reference sequences and including the sequence of words in the query candidate set if the sequence of tags matches the one or more reference sequences. Each tag of the sequence of tags represents a part of speech.

### CROSS REFERENCE TO RELATED APPLICATIONS

This application claims the benefit of corresponding Indian Patent Application titled “Method And Apparatus For Generating A Query Candidate Set” filed on Jun. 18, 2013, which is a non provisional application of the Indian Provisional Patent Application titled “Method and Apparatus for Query Candidate Extraction” filed on Jun. 25, 2012, both having the Application No. 1820/MUM/2012, which are herein incorporated by reference in their entirety.

### BACKGROUND

1. Field of the Invention

Embodiments of the present invention generally relate to search queries, and more particularly, to a method and apparatus for generating a query candidate set.

2. Description of the Related Art

Search query suggestions are predicted by most search engines to enhance the searching experience. These predictions may be made based on various contexts such as user profile, search history and geography among others. For providing these suggestions in real time the search engine needs to be able to access a set of query candidates. The set of query candidates are used by the search engine to provide meaningful suggestions.

These query candidates are generally obtained from queries already submitted by users. Conventional solutions rely significantly on this approach of using historically fired queries. However, query candidates generated using historically fired queries suffer from various limitations. For efficient query candidates to be generated a significant and substantially huge number of historically fired queries are required. Further, the query candidates generated from historically fired query candidates capture only historic data and are likely to be oblivious to recently available data. Such recently available data may not be captured in the query candidates generated from historically fired queries because such data may not have been searched for as yet. Such limitation of query candidates being oblivious to recently available data is more pronounced in the context of rapidly changing content such as news articles.

Therefore, there is a need for a method and apparatus for generating a query candidate set.

### SUMMARY OF THE INVENTION

Embodiments of the present invention provides a method and apparatus for generating a query candidate set. The method comprises automatically tagging a sequence of words in a digital document to obtain a sequence of tags, comparing the sequence of tags with one or more reference sequences and including the sequence of words in the query candidate set if the sequence of tags matches the one or more reference sequences. Each tag of the sequence of tags represents a part of speech.

### BRIEF DESCRIPTION OF THE DRAWINGS

FIG. 1 depicts a schematic diagram of a system for generating a query candidate set;

FIG. 2 depicts a schematic diagram of a query candidate set generator of FIG. 1 according to an embodiment of the present invention;

FIG. 3 depicts a flow diagram of a method for obtaining one or more reference sequences according to an embodiment of the present invention;

FIG. 4 depicts a flow diagram of a method for generating a query candidate set according to an embodiment of the present invention; and

FIG. 5 depicts a flow diagram of a method of expanding the query candidate set of FIG. 4 according to an embodiment of the present invention.

While the method and apparatus is described herein by way of example for several embodiments and illustrative drawings, those skilled in the art will recognize that the method and apparatus for generating a query candidate set are not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for generating query candidate set as illustrated by various embodiments. Any headings used herein are for organizational purposes only and are not meant to limit the scope of the description or the embodiments. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Embodiments of the present invention comprise a method and apparatus for generating a query candidate set. The technique described herein generates a query candidate set from a digital document. A sequence of words such as, a phrase or clause or sentence extracted from the digital document is automatically tagged using generally known in the art, automated parts of speech (POS) tagger. The POS tagger assigns a POS tag to each word in the sequence of words and generates a sequence of tags. The sequence of tags is matched to one or more reference sequences. The one or more reference sequences is obtained by tagging each of multiple search queries received on a search engine. The search engine may be any system used for automatically retrieving results by searching the web or a digital database in response to a query received from a user. If the sequence of tags matches any of the one or more reference sequences, the sequence of words is identified as a query candidate and included in the query candidate set. As identification of query candidates is based on match with the one or more reference sequences acquired by tagging actual search queries received, the query candidates identified are very similar to actual search queries that may be received on a search engine. Those skilled in the art will appreciate that the one or more reference sequences capture real world searching behavior of a user. Further, as query candidates are extracted from digital documents that are likely to be part of data to be used by the search engine, the query candidates have a high probability of providing a successful search and good search result. Another advantage of extracting query candidates from digital documents is capture of data irrespective of whether such data has been searched before or not. Capturing data that has not been searched before helps generating search queries that introduce new data to be searched to the user.

In the following detailed description, numerous specific details are set forth to provide a thorough understanding of the disclosed subject matter. However, it will be understood by those skilled in the art that disclosed subject matter may be practiced without these specific details. In other instances, methods, apparatuses or systems that would be known by one of ordinary skill have not been described in detail so as not to obscure disclosed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the art to convey the substance of their work to others skilled in the art. An algorithm is here, and is generally, considered to be a self-consistent sequence of operations leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

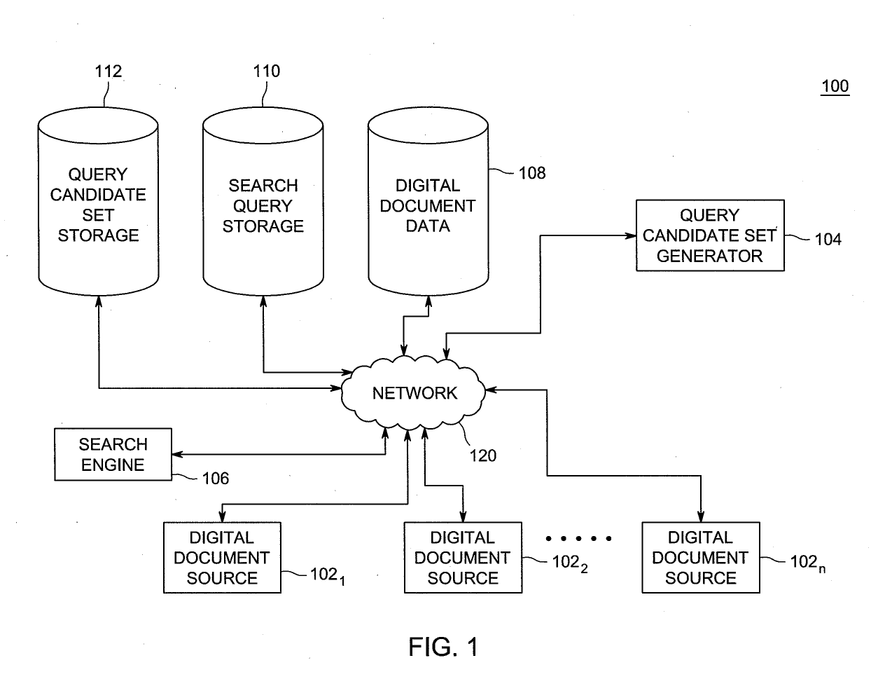

Embodiments of the present invention provide a method and apparatus for generating a query candidate (QC) set. FIG. 1 depicts a block diagram depicting a system 100 for generating a QC set according to one or more embodiments of the invention. The system 100 comprises one or more digital document sources 102, (multiple digital document sources illustrated in FIG. 1 by numerals 102₁, 102₂, . . . 102ₙ), a query candidate set generator 104, a search engine 106, a digital document data 108, a search query storage 110, a QC set storage 112 and a network 120.

In some embodiments, the network 120 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface may support communication via wired or wireless general data networks, such as any suitable type of Ethernet network, for example; via telecommunications/telephony networks such as analog voice networks or digital fiber communications networks; via storage area networks, such as Fiber Channel SANs, or via any other suitable type of network and/or protocol.

The one or more digital document sources 102ₙ, the QC set generator 104, the search engine 106, the digital document data 108, the search query storage 110 and the query candidate set storage 112 are computing devices configured for exchanging digital content over the network 120, processing and displaying such content and providing a user interface. The one or more digital document sources 102ₙ are computing devices for example, used by publishers to publish news articles. The digital documents may be a news article, a shopping catalogue, books, deals, images, job listings, Wikipedia articles and the like. The QC set generator 104 is a computing device that enables generation of the QC set. The QC set storage 112 includes computing devices storing the QC set generated by the QC set generator 104. The digital document data 108 includes computing devices having digital documents, for example news articles, metadata related to the digital documents and the like. The search engine 106 is a computing device from which a search query is received, and to which a results of the search query processing may be displayed. The search query storage 110 includes computing devices storing search queries received at the search engine 106. Those skilled in the art will appreciate that the various functionalities of the digital document sources 102ₙ, the QC set generator 104, the search engine 106 and the digital document data 108 can be configured differently, for example, using the devices of the apparatus 100 for different functionality, or using other devices communicably coupled to the network 120 to achieve these functionalities, and similar such configurations, all of which are included within the scope and spirit of the invention.

According to several embodiments, the apparatus 100 includes a digital document sourcing module, for example, a News Crawler (not shown). The digital document sourcing module is responsible for crawling multiple digital document sites, such as news sites at regular intervals. According to several embodiments the digital sourcing module provides digital documents for further processing according to various embodiments.

According to some embodiments, content of the digital document may be available in readily usable form, such as from an RSS feed or other classified content providing agents that provide content feed identified and classified according to customized requirements. For example, a content providing agent may provide content of the digital document identified as title and description. According to other embodiments, the apparatus 100 may include a component extracting module (not shown) implemented by a technique generally known in the art for extracting the text, images and other components from the digital document. In some embodiments, the component extracting module downloads actual URL of the digital document to obtain entire content of the digital document to use for extracting, searching and scoring. The component extracting module may comprise an HTML parser or may specifically analyze the DOM structure of the HTML of the digital document, and extract text of the digital document. In the process, the component extracting module strips out irrelevant components of the digital document such as advertisements, navigational links, user comments, and the like. The text of the digital document, for example, extracted by the component extracting module is used by the QC set generator 104 to generate the QC set.

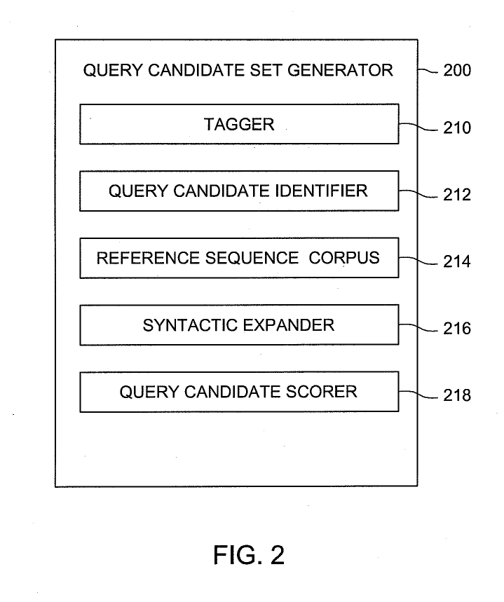

FIG. 2 depicts a block diagram of a QC set generator 200 for generating the QC set, similar to the QC set generator 104 of FIG. 1, according to one or more embodiments of the invention. In some embodiments, the QC set generator 200 is a type of computing device (e.g., a laptop, a desktop, a Personal Digital Assistant (PDA) and/or the like) known to one of ordinary skill in the art. The QC set generator 200 comprises a tagger 210, a QC identifier 212, a reference sequence corpus 214, a syntactic expander 216, and a QC scorer 218. The tagger 210 tags sequence of words, such as a phrase, clause or sentence from the digital document stored in for example, the digital document data 108 of FIG. 1. A POS tagger generally known in the art, for example, Stanford University POS tagger or Natural language Toolkit (NLTK) may be used for tagging the sequence of words. In order to handle contents of sequence of words other than generally known in the art parts of speech (POS), such as noun, pronoun, adjective, verb, adverb, conjunctions and prepositions, the tagger 210 additionally assigns specific tags for numbers and possessive apostrophe. For example, ‘3 idiots’ is tagged to obtain ‘CD NNS’, ‘Sachin Tendulkar's Ferrari’ is tagged to obtain ‘NNP NNP POS NNP’. A sentence ‘Sachin Tendulkar's Ferrari bought by Surat businessman’ may be tagged to obtain a sequence of tags ‘Sachin/NNP Tendulkar/NNP ‘s/POA Ferrari/NNP boughtNBN by/IN Surat/NNP businessman/NNP’. The tag NNP indicates a proper noun, POA indicates possessive apostrophe (possessive apostrophe is represented by ‘POS’ in generally known in the art parts of speech tagger, however ‘POA’ is used herein to represent possessive apostrophe to prevent confusion with acronym for parts of speech ‘POS’), VBN indicates a verb past participle, IN indicates a preposition and CD indicates a cardinal number. Further to enhance coverage, multiple sequences of tags are obtained around a word. For example, ‘Sachin Tendulkar's Ferrari’ (NNP NNP POA NNP) is the longest phrase for the word ‘Sachin’. The QC set generator 200 is configured to obtain both phrases, ‘Sachin Tendulkar’ and ‘Sachin Tendulkar's Ferrari’. Either such capability is provided by the component extracting module adapted to extract multiple lengths of sequence of words around a word or the QC generator 200 uses a separate dedicated module to obtain multiple lengths of sequence of words around a word.

The reference sequence corpus 214 stores the one or more reference sequences obtained by tagging each of the multiple search queries received on search engine, for example search engine 106 of FIG. 1. Efficiency of the one or more reference sequences allows for efficiency of extraction of meaningful phrases as query candidates. A general expectation is that reference sequences that match spoken language would be most effective. However, it was advantageously discovered that web search behavior of users led to different kind of search query formations. The one or more reference sequences stored in the reference sequence corpus 214 include examples such as NN IN NNP (map of India), JJ NNP (pregnant Aishwarya) JJ (Adjective) NN (Noun) that do not match spoken language. According to an embodiment, the reference sequence corpus 214 stores multiple reference sequences of tags approved or desirable in a query candidate. Using reference sequences obtained from tagging search queries provides distinct advantage of factoring in real world searching behavior of users. Further syntactic variations in search queries are accounted for by implementation of the syntactic expander 216. Those skilled in the art will appreciate that syntactic variations of a search query or a sequence or words may include sequence of words having same meaning expressed using different structures of a language. Also, exploring the real world searching behavior elucidates that search queries may not abide by legitimate rules of grammar and structures of the language and may simply be legitimate and illegitimate variations of legitimate structures of the language. The syntactic expander 216 expands the QC set to include syntactic variations of QCs and implementation of the syntactic expander 216 is explained in detail below.

The QC identifier 212 compares the sequence of tags to the one or more reference sequences. The sequence of tags is obtained by tagging the sequence of words from the digital document and is compared to each of the one or more reference sequences stored in the reference sequence corpus 214. If the sequence of tags matches any of the one or more reference sequences in the reference sequence corpus 214, the sequence of words tagged to obtain the sequence of tags is identified and referred to as a query candidate (QC). The identified QC is included in the QC set and stored as for example, the QC set 112 of FIG. 1. Implementation of the QC identifier is explained in more detail below.

According to some embodiments, the QC scorer 218 assigns a score to each QC of the QC set, stored for example in QC set storage 112 of FIG. 1. Those skilled in the art will appreciate that the scores may be used for ranking the QCs. For example, a QC with highest score among multiple QCs assigned the score may be considered to have the highest rank and similarly other QCs having score lower than the highest score may form an ordered list in descending order of score and rank. The score is computed according to one or more features. As is described above, the QCs are extracted from the digital document sourced from the one or more digital document sources 120_{1 . . . n} Accordingly, multiple digital documents may be used to generate the QC set. A QC of the QC set may occur in multiple digital documents or may occur in only one digital document from the multiple digital documents used to generate the QC set. Various attributes of the QC such as occurrence of the QC in the multiple digital documents, significance of information of content the QC is captured by the one or more features. The one or more features may be obtained from metadata associated with each digital document containing the sequence of words or QC included in the QC set. The one or more features represents one of, number of digital document containing the sequence of words, number of times the sequence of words occurs in the digital document, location of the sequence of words in the digital document, credibility of the digital document, recency of the digital document, category of content of the digital document, length of the sequence of words and originating geography of the digital document.

Number of digital document from the multiple digital documents containing the sequence of words which is identified as a QC, for example, may be represented as document frequency (DF). Similarly, number of times the sequence of words occurs in title or description of each of the digital documents, for example, may be represented as term frequency (TF). For example, consider two digital documents DD 1 and DD 2. DD 1 is titled ‘Sachin Tendulkar sells Ferrari to Surat Businessman’ and DD 1 description includes ‘Sachin Tendulkar has sold his Ferrari, finally. The Ferrari was purchased by a businessman in Surat for an amount of $100000.’. DD 2 is titled ‘Sachin Tendulkar's Ferrari sold for record price’, and DD 2 description includes ‘Navin Shah, a businessman from Surat has bought Sachin's Ferrari.’. In this example, the TF for ‘Ferrari’ is 1+2+1+1=5, while DF for ‘Ferrari’ is 2.

The location of the sequence of words in the digital document may be, for example, the title, beginning of description etc. and may signify importance of the sequence of words in the digital document. The credibility of each of the digital documents containing the sequence of words may be related to, for example, publisher credibility, impact factor of scientific journals, website credibility etc. The category of the digital document is a feature to indicate whether the article relates to politics, sports, entertainment, weather or several other categories as will occur to those skilled in the art. Such scoring provides a means for identifying QCs based on preferred features. For example, recency of the digital document enables capturing QCs that are temporally significant. Similarly, feature of originating geography allows comparative analysis between digital documents originating from preferred country (for example, India) with respect to digital documents originating from rest of the world. Such comparison is a part of the identifying and/or introducing a regional bias in the QC set.

According to an embodiment, the QC may be scored based on whether or not words of the QC are named entity. Those skilled in the art will appreciate that named entities are generally recognized by Named Entity Recognizers to identify entities such as people, companies and organizations. For example, ‘Sachin Tendulkar’, ‘Infosys’ and ‘Bharatiya Janata Party’. According to another embodiment the QCscorer 218 may assign higher score to longer QCs to enhance information contained in the QC. For example, considering following three QCs: a) Manmohan, b) Singh, and c) Manmohan Singh. The QC scorer 218 recognizes c) Manmohan Singh as more informative and assigns highest score out of the 3 considered QCs. Though, having a low score, ‘Singh’ is considered as a QC because of its presence as a single word QC in several digital documents. Further, according to one embodiment, shorter QC such as ‘Singh’ may be scored higher than longer QC such as ‘Manmohan Singh’ because the shorter QC is assigned higher score due to features other than length such as TF and DF among others. For example, if ‘Singh’ occurs in many more digital documents and with a much higher frequency than ‘Manmohan Singh’, ‘Singh’ is assigned a higher score than ‘Manmohan Singh’.

According to some embodiments the QC set generator 200 includes an iterative learning module (not shown). The iterative learning module continually uses queries received on the search engine for example, the search engine 106 of FIG. 1 to improve the reference sequences stored in the reference sequence corpus 214 by learning new reference sequences of tags from search queries received. Various learning technologies such as those generally known in the art, e.g. machine learning, neural networks etc. may be employed by the iterative learning module.

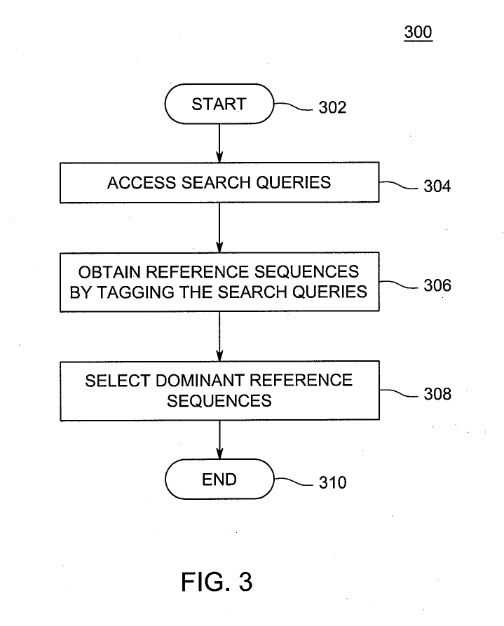

FIG. 3 depicts a flow diagram of a method for obtaining one or more reference sequences according to an embodiment of the present invention. The one or more reference sequences are obtained by tagging the multiple search queries stored in for example, the search query storage 110 of FIG. 1. The search query storage 110 stores the multiple search queries fired on any automated search retrieval system such as a web based search engine. The method 300 starts at step 302, and proceeds to step 304. At step 304, the method 300 accesses each of the multiple search queries. At step 306, the method 300 obtains the one or more reference sequences of tags by tagging each of the multiple search queries. The multiple search queries may be tagged using generally known in the art POS tagger, for example, similar to the tagger 210 of FIG. 2. At step 306 multiple reference sequences are obtained by tagging each of the multiple search queries. At step 308, the method 300 selects one or more dominant reference sequences from the multiple reference sequences obtained. The method 300 selects the one or more reference sequences as the one or more dominant reference sequences based on number of times the one or more reference sequences is obtained by tagging each of the multiple search queries. For example, the one or more reference sequences is selected as dominant reference sequence if the reference sequence is obtained most number of times among the multiple reference sequences obtained by tagging the multiple search queries. Further, number of one or more dominant reference sequences to be selected may be specified. Accordingly, specified number of dominant reference sequences may be selected in descending order of number of times the reference sequence is obtained. For example, if the number of dominant reference sequence to be selected is specified as 100, 100 reference sequences are selected from the multiple reference sequences obtained, in descending order of number of times of being obtained by tagging the multiple search queries. Those skilled in the art will appreciate, purpose of selecting one or more dominant reference sequences is to capture most commonly or repeatedly fired pattern of search queries. Such dominant reference sequences are helpful in identifying useful query candidates. The method 300 proceeds to step 310 and ends.

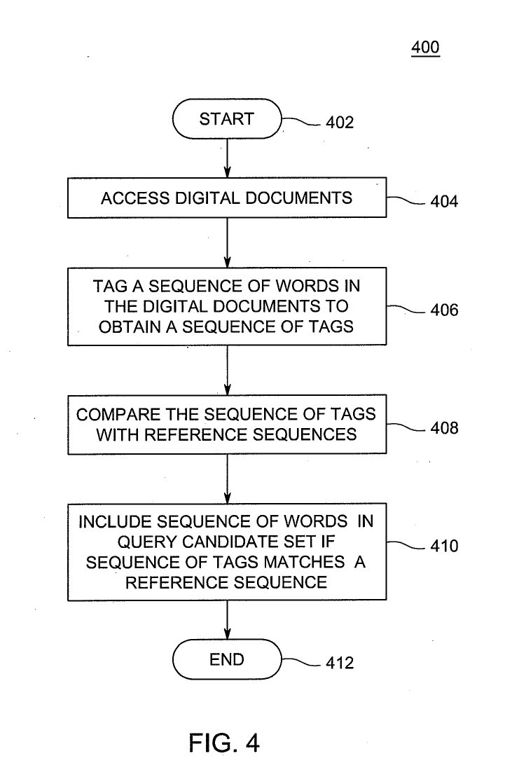

FIG. 4 depicts a flow diagram of a method for generating a QC set using the apparatus of FIG. 1, for example using the digital document data 108, the search query storage 110 and the QC identifier 212 of FIG. 2, according to one or more embodiments of the invention. The method 400 starts at step 402, and proceeds to step 404. At step 404, the method 400 accesses the digital documents stored as for example, digital document data 108 of FIG. 1. At step 406, the method 400 tags the sequence of words extracted from the digital document to obtain a sequence of tags. The sequence of words may be tagged by for example, the tagger 210 of FIG. 2.

At step 408, the method 400 compares the sequence of tags obtained by tagging the sequence of words of the digital document with the one or more reference sequences stored in for example, the reference sequence corpus 214. According to one embodiment, at step 408, the sequence of tags may be compared with the one or more dominant reference sequences obtained as described above with respect to FIG. 3. At step 410, if the sequence of tags matches any of the one or more reference sequences, the sequence of words from which the sequence of tags is obtained is included in the QC set. The method 400 proceeds to step 412 and ends.

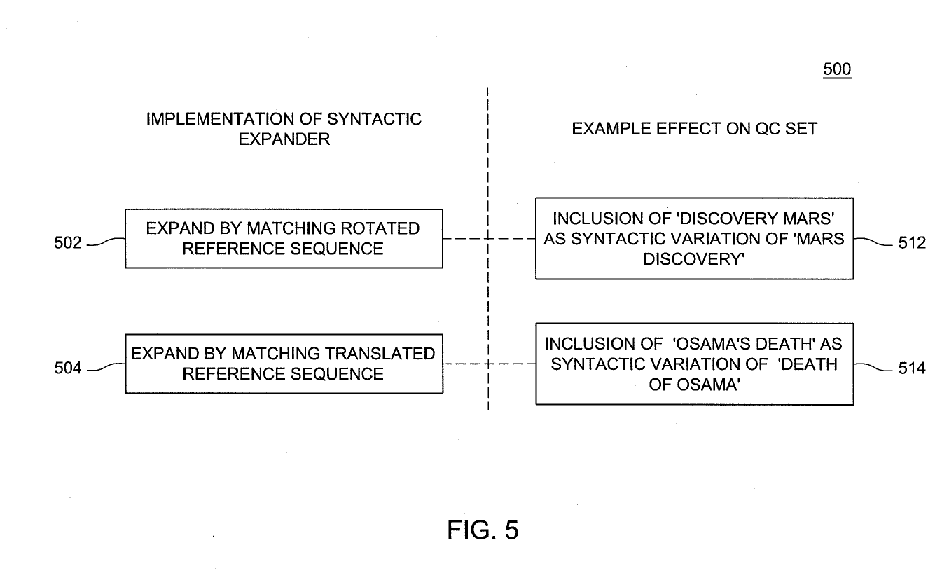

FIG. 5 depicts effect of implementation of syntactic expander 216, according to an embodiment of the present invention. The syntactic expander 216 may expand the QC set by inclusion of sequence of words which when tagged generates syntactic variations of the one or more reference sequences. For example, the syntactic expander 216 may be implemented by recognizing a sequence of words in digital documents as syntactic variation of the one or more reference sequences. Syntactic variations of the one or more reference sequences may be obtained using known in the art natural language processing techniques. Such natural language processing techniques used for obtaining and identifying syntactic variations of the reference sequence may include rotation of words and translation of possessive apostrophe among others.

Rotation of words is generally implemented between pairs of words and includes change in order of words in the identified QC. As depicted in 502 and 512, the syntactic expander may recognize that the sequence of words matches a rotated one or more reference sequences. Rotation may be implemented between a pair of tags. For example, consider, mars discovery' is selected as a QC because of matching with the one or more reference sequences. Rotation adds ‘discovery mars’ to the QC set as ‘discovery mars’ matches the rotated reference sequence for ‘mars discovery’. Similarly, impact of translation of possessive apostrophe on QC set is depicted in 504 and 514. For example, reference sequence ‘NN IN NNP’ obtained from a query ‘Death of Osama’ is translated to ‘NNP POA NN’ representing a syntactic variation. The impact on the QC set is addition of ° same's death' to the QC set. In some embodiments, there are high chances of the digital document having one syntactic variation of the QC and almost zero for other forms. Rotation and translation overcome such limitation. Though, those skilled in the art will appreciate that the one or more reference sequences obtained from tagging the multiple search queries is more valuable for identifying QCs than syntactic variations as the one or more reference sequences capture real world searching behavior.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

In some embodiments, the illustrated computer system may implement any of the methods described above, such as the methods illustrated by the flowcharts of FIG. 3. In other embodiments, different elements and data may be included.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of the invention. Finally, structures and functionality presented as discrete components in the example configurations may be implemented as a combined structure or component. These and other variations, modifications, additions, and improvements may fall within the scope of embodiments as defined.

The foregoing is directed to embodiments of the present invention, other and further embodiments of the invention may be devised without departing from the basic scope thereof.

What is claimed is:

1. An apparatus for generating a query candidate set, the apparatus comprising:
a tagger for automatically tagging a sequence of words in a digital document to obtain a sequence of tags; and
a query candidate identifier for
comparing the sequence of tags with at least one reference sequence; and
including the sequence of words in the query candidate set if the sequence of tags matches the at least one reference sequence, wherein each tag of the sequence of tags represents a part of speech.

2. The apparatus of claim 1, wherein the tagger automatically tags each of a plurality of search queries received on a search engine to obtain the at least one reference sequence.

3. The apparatus of claim 2, wherein the at least one reference sequence comprises a plurality of reference sequences.

4. The apparatus of claim 3, wherein the query candidate identifier identifies at least one dominant reference sequence from the plurality of reference sequences based on number of times each of the plurality of reference sequences is obtained.

5. The apparatus of claim 1, further comprising a syntactic expander for comparing the sequence of tags with a syntactic variation of the at least one reference sequence, the syntactic variation and the at least one reference sequence differing by at least one of a tag for possessive apostrophe or order of tags.

6. The apparatus of claim 5, wherein the syntactic expander includes the sequence of words in the query candidate set if the sequence of tags matches the syntactic variation of the at least one reference sequence.

7. The apparatus of claim 1, further comprising a query candidate scorer for assigning a score to the sequence of words included in the query candidate set according to a feature of the sequence of words.

8. The apparatus of claim 7, wherein the feature represents at least one of number of the digital documents containing the sequence of words, number of times the sequence of words occurs in the digital document, location of the sequence of words in the digital document, credibility of the digital document containing the sequence of words, recency of the digital document containing the sequence of words, category of content of the digital document containing the sequence of words, length of the sequence of words, or originating geography of the digital document containing the sequence of words.

9. A method for generating a query candidate set, the method comprising:
automatically tagging a sequence of words in a digital document to obtain a sequence of tags using an automated parts of speech tagger;
comparing the sequence of tags with at least one reference sequence stored in a reference sequence corpus; and
including the sequence of words in the query candidate set, stored in query candidate set storage, if the sequence of tags matches the at least one reference sequence, wherein each tag of the sequence of tags represents a part of speech.

10. The method of claim 9, wherein the at least one reference sequence is obtained by automatically tagging each of a plurality of search queries received on a search engine, using the automated parts of speech tagger.

11. The method of claim 10, wherein the at least one reference sequence comprises a plurality of reference sequences.

12. The method of claim 11, wherein at least one dominant reference sequence is identified from the plurality of reference sequences based on number of times each of the plurality of reference sequences is obtained.

13. The method of claim 9, the method further comprising comparing the sequence of tags with a syntactic variation of the at least one reference sequence, the syntactic variation and the at least one reference sequence differing by at least one of a tag for possessive apostrophe or order of tags.

14. The method of claim 13, the method further comprising including the sequence of words in the query candidate set, if the sequence of tags matches the syntactic variation of the at least one reference sequence, using a syntactic expander.

15. The method of claim 9, wherein the sequence of words included in the query candidate set is assigned a score computed according to a feature of the sequence of words using a query candidate scorer.

16. The method of claim 15, wherein the feature represents at least one of number of the digital documents containing the sequence of words, number of times the sequence of words occurs in the digital document, location of the sequence of words in the digital document, credibility of the digital document containing the sequence of words, recency of the digital document containing the sequence of words, category of content of the digital document containing the sequence of words, length of the sequence of words, or originating geography of the digital document containing the sequence of words.

17. A non-transient computer readable storage medium for storing computer instructions that, when executed by at least one processor cause the at least one processor to perform a method for generating a query candidate set, the method comprising:
automatically tagging a sequence of words in a digital document to obtain a sequence of tags using an automated parts of speech tagger;
comparing the sequence of tags with at least one reference sequence stored in a reference sequence corpus; and
including the sequence of words in the query candidate set, stored in query candidate set storage, if the sequence of tags matches the at least one reference sequence, wherein each tag of the sequence of tags represents a part of speech.
